(19) United States
(12) Patent Application Publication
(10) Pub. No.: US 2011/0229848 A1
(43) Pub. Date: Sep. 22, 2011

(54) TOOTH-WHITENING APPLIANCE

(76) Inventor: Paul HERTZ, Bronx, NY (US)

(21) Appl. No.: 13/151,767

(22) Filed: Jun. 2, 2011

Related U.S. Application Data
(63) Continuation-in-part of application No. 12/885,692, filed on Sep. 20, 2010.
(60) Provisional application No. 61/245,015, filed on Sep. 23, 2009.

(51) Int. Cl. A61C 17/20

(52) U.S. Cl. 433/119

(57) ABSTRACT

An appliance for activating a tooth-whitening agent has a source of ultrasonic vibration having an active ultrasonically agitated tip. A holder is fittable over the tip and carries a vibration-conducting fork engageable between the upper teeth and lower teeth of a patient and in contact with the tip for transmitting ultrasonic vibrations from the tip to the patient's teeth.

### CROSS REFERENCE TO RELATED APPLICATION

This application is a continuation-in-part of copending application Ser. No. 12/885,692 filed 20 Sep. 2010 with a claim to the priority of U.S. provisional application 61/245,015 filed 23 Sep. 2009.

### FIELD OF THE INVENTION

The present invention relates to tooth whitening. More particularly this invention concerns an appliance for use in a tooth-whitening process.

### BACKGROUND OF THE INVENTION

In above-cited copending patent application Ser. No. 12/885,692, a tooth-whitening method is described in which chlorine dioxide is applied to surfaces of the teeth, and left on the teeth for a predetermined time. The solution is then rinsed from the teeth, the chlorine-dioxide application and rinsing is repeated at least once, and finally tubule sealant is applied to the tooth surfaces.

Such a procedure is highly effective, and can be enhanced by the application of energy to the the teeth to ensure activation of the chlorine-dioxide solution and the tooth surfaces.

Standard practice is to use light, heat, and sonic and ultrasonic energy to activate the chlorine disoxide. Conventional tooth bleaching has traditionally used light in a variety of spectrums and from numerous varied sources. The most common sources include lasers, LED lights and halogen-white light. In the above-cited parent application, the use of ultrasonic energy is proposed.

### OBJECTS OF THE INVENTION

It is therefore an object of the present invention to provide an improved appliance for enhancing the above-described tooth-whitening procedure.

Another object is the provision of such an improved tooth-whitening appliance that is easy to use, comfortable for the patient, and effective in promoting the whitening action of the known method.

### SUMMARY OF THE INVENTION

An appliance for activating a tooth-whitening agent has according to the invention a source of ultrasonic vibration having an active ultrasonically agitated tip. A holder is fittable over the tip and carries a vibration-conducting fork engageable between the upper teeth and lower teeth of a patient and in contact with the tip for transmitting ultrasonic vibrations from the tip to the patient's teeth.

Thus with this system the relatively massive fork is used to transmit ultrasonic vibrations to the patient's teeth, thereby activating the whitening agent. Due to the fact that the fork has a mass many times greater than that of the ultrasonic scaler tip, the heat generated by the ultrasonic energy is dissipated over a greater area and is not a problem, in fact is barely perceptible.

This system has been found very effective in activating the whitening agent, and affects all the teeth, unlike the system using irradiation that must be used expertly and that does not get to all surfaces.

The fork according to the invention is made of metal and has generally planar upper and lower faces. It has a U-shaped end dimensioned to fit the dental arch of the patient.

The holder is tubular and adapted to fit over the source of ultrasonic vibration. The rear end of the one-piece metal fork fits into this tubular holder and is formed with a socket complementary to the tip of the scaler for good energy transmission from the scaler to the metal mouthpiece/fork.

### BRIEF DESCRIPTION OF THE DRAWING

The above and other objects, features, and advantages will become more readily apparent from the following description, reference being made to the accompanying drawing in which:

FIG. 1 is a top view of the assembled appliance according to the invention;

FIG. 2 is a top view of the partially disassembled appliance; and

FIG. 3 is a perspective end view of the appliance from the front and top.

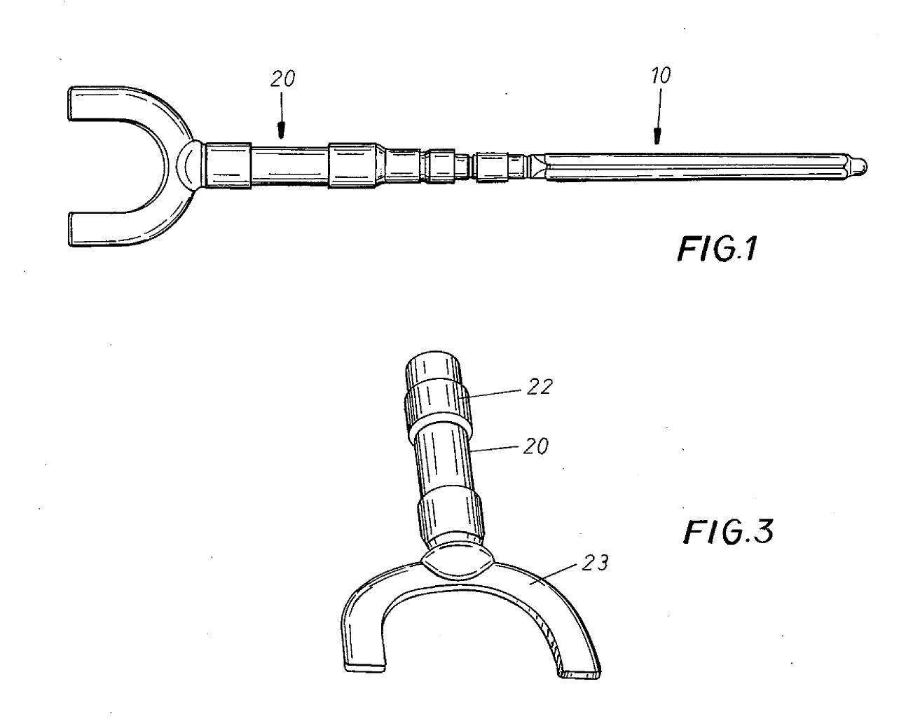

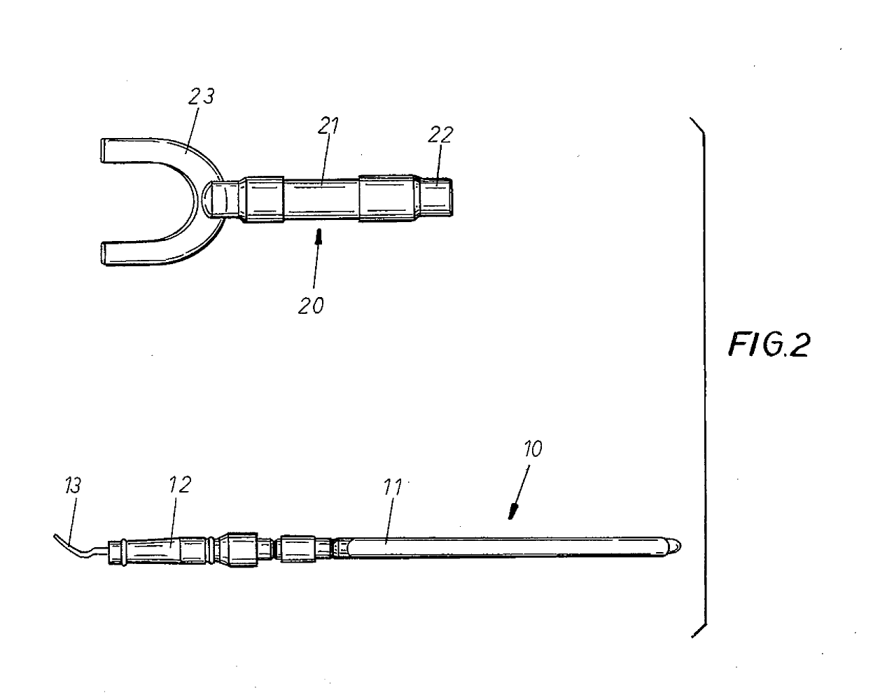

### SPECIFIC DESCRIPTION

As seen in the drawing, the invention basically is a standard so-called beaver-tail 30 kHz scaler 10 combined with a fork accessory 20 adapted to transmit energy from the scaler 10 to the patient's teeth.

More particularly the scaler 10 includes the standard scaler handle or shaft 11 that holds the transducer creating the required high-frequency vibrations and a tool 12 carrying the metallic beaver-tail tip 13. This scaler 10 is the standard dental tool used for cleaning and normally fitted with a sprayer to dissipate the heat generated by the mechanical action at the tip 13.

The accessory 20 according to the invention comprises a tubular sleeve or socket 21 adapted to fit over the tool 12 and internally shaped to snugly receive the tip 13. A plastic sleeve 22 at the rear end of the sleeve 21 ensures a snug fit with the tool 21. At its outer end, the accessory 20 has a U-shaped fork dimensioned to fit the standard dental arch of a patient, being of course available in several sizes for jaws of different size. The fork 23 is made of fairly rigid sheet metal so that it acts as a heat sink, eliminating the need of the cooling spray typically used with the scaler 10.

After coating the teeth with the solution of chlorine dioxide (or hydrogen peroxide and carbamide peroxide), this fork 23 is placed in the patient's mouth and pressed against the upper teeth, then against the lower teeth, or vice versa. The ultrasonic vibrations, which are barely physically perceptible, are transmitted to the coated teeth and activate the bleaching agent coating them.

The coating process followed by the ultrasonic activation step with the tool according to the invention is followed by a rinsing as disclosed in the parent application. Then the teeth are recoated, the coating is ultrasonically activated, and the teeth are rinsed again one or more times until the desired whitening effect is attained.

After the final rinsing the tubules of the enamel and exposed dentin are left open. Since exposed enamel rods are vulnerable to staining from food and smoke, a clear very flowable resin is used to seal the open tubules and rods of the just bleached teeth to slow or the problem of restaining

I claim:

1. An appliance for activating a tooth-whitening agent, the appliance comprising:
a handle:
a source of ultrasonic vibration having an active ultrasonically agitated tip and mounted in the handle;
a holder fittable over the tip; and
a vibration-conducting fork engageable between the upper teeth and lower teeth of a patient and contact with the tip for transmitting ultrasonic vibrations from the tip to the patient's teeth.

2. The appliance defined in claim 1 wherein the fork is made of metal.

3. The appliance defined in claim 2 wherein the fork has generally planar upper and lower faces.

4. The appliance defined in claim 3 wherein the fork has a U-shaped end dimensioned to fit the dental arch of the patient.

5. The appliance defined in claim 4 wherein the holder is tubular and adapted to fit over the source of ultrasonic vibration.

6. The appliance defined in claim 5 wherein the source is an ultrasonic scaler.
